(19) United States
(12) Patent Application Publication
(10) Pub. No.: US 2007/0044126 A1
(43) Pub. Date: Feb. 22, 2007

(54) Wireless video entertainment system

(75) Inventor: James P. Mitchell, Cedar Rapids, IA (US)

Correspondence Address: Kyle Eppele;ROCKWELL COLLINS, Inc., 400 Collins Rd, NE, M/S 124-323, Cedar Rapids, IA, 52498, US

(73) Assignee: Rockwell Collins, Inc.

(21) Appl. No.: 11/207,037

(22) Filed: Aug. 18, 2005

(51) Int. Cl. H04N 7/18

(52) U.S. Cl. 725/81; 725/75

(57) ABSTRACT

A system is provided for wireless video entertainment including sources of video, audio and/or data signals. A server processes and stores the video signal prior to transmission to a personal electronic device (“PED”) of a user. Transmission to the PED is wireless via a multi-band RF access module positioned in close proximity to the PED. The PED may be a laptop computer, cell phone, touch display unit or other device capable of receiving and processing a digitized video signal. The access module includes a RF power combiner for unique bundling and isolation of a plurality of video signals throughout the transmission process. An audio signal may be synchronized or isochronously transported with a video signal and transmitted via an audio module to a wireless audio receiver, such as a headset. Further, data signals for Internet and email use are provided. System and GUI software facilitate operation of the system.

### FIELD OF THE INVENTION

This invention relates generally to multi-media entertainment systems. More particularly, this invention relates to a wireless video entertainment system, and specifically to wireless visual, audio and data delivery and playback systems.

### BACKGROUND

Multi-media entertainment has become a standard service provided on commercial transports. In commercial aircraft, for example, passengers may select from a variety of pre-recorded videos, real or near-real time broadcast video, and a plethora of audio channels. The same may be said for commercial rail, ocean going vessels, etc. While these services have enhanced the pleasure of commercial travel, they are not without limitations. By way of example, current systems do not typically incorporate Internet/email access as part of the services provided. Users most often must use personal devices such as laptops to establish their own, independent link to a data signal for Internet/email use.

Media systems based solely or primarily on wire interconnects (i.e. wires, cables, etc.) require significant quantities of wires and cables that must be routed throughout, for example, the passenger compartments of an aircraft. Wires and cables require space in an environment where space is already limited. Further, wires, cables, connectors, etc. add weight to a vehicle, and increased weight equates to increased operational costs. Moreover, the user has limited or no mobility while using a wired system, in as much as the video signal is delivered to a specific and fixed location (such as a passenger seat) over a wire connection.

Wireless systems for delivering video, data and/or audio signals overcome many of the limitations discussed above. However, wireless systems typically suffer from power loss, bandwidth limitations, frequency interference, synchronization incompatibilities, some systems still require many wires depending on the network topology, as well as other such problems. To begin with, the structure itself of an aircraft or other commercial vehicle is a limiting factor for wireless systems. As shown in FIG. 1, an aircraft cabin 100 may be divided into several passenger compartments, e.g. compartments 102 and 104. The transmission of an RF signal throughout the compartments 102, 104, from a source 106 located in a forward compartment of the aircraft, will be subject to various RF signal fade phenomena. In particular, there will be areas of Ricean fading (areas 108, 110 and 112). In these areas, there is a direct, or at least dominant, component in the mix of signals that reach a receiver. These areas may be described as having acceptable to marginally acceptable line-of-sight reception of a broadcasted RF signal, primarily due to their proximity and their line-of-sight orientation with the source. The quality of the received video signal, however, degrades as a function of distance and orientation. Rayleigh fading (i.e. multiple indirect paths between transmitter and receiver, with no distinct dominant path) will impact signal quality in regions 114 and 116, which are not in a direct line-of-sight relationship with the signal source 106. In both instances (Ricean and Rayleigh fading), the quality of the video signal degrades in proportion to the distance traveled by the signal.

In addition to the fading phenomena discussed above, blockage of a wireless RF signal can be a significant problem. Passengers, crew members, seats, food carts—any and all of these realities of commercial air travel can block a transmitted RF signal, thereby degrading the quality of the video signal ultimately received by a user. In combination with Ricean and/or Rayleigh fading, signal blockage can result in an attenuation of the RF link between source and receiver, e.g. attenuations in excess of 25 dB have been observed. Loss can equate to a partial or complete loss of signal reception for all but the closest seats and rows.

A partial solution to the problem of Ricean/Rayleigh fading and signal blockage is to employ multiple signal sources 106 throughout the passenger compartments 102, 104. While attractive on its face, this solution can introduce problems with multiple signal interference, which leads in turn to undesired intersymbol interference and RF intermodulation. The RF by-products of intermodulation may be a significant detriment to FAA certification of wireless video entertainment systems. Signal interference is further enabled by the fact that Commercial Off-the-Shelf (“COTS”) hardware typically requires some degree of miniaturization and dense packaging to fit within the limited spaces available on an aircraft or other commercial transport. The closer components are to one another, the greater the possibility of signal interference.

Equally as problematic may be the use of COTS components which purposely emit RF signals in frequency bands reserved for aviation related transmissions. Typically, aviation MLS (microwave landing systems) operate at 5.15 to 5.20 GHz using 802.11a radio systems. Transmission at these frequencies by components of a video entertainment system will most certainly prevent FAA certification of the system. Further, COTS wireless systems often lack adequate bandwidth to service a large number of users simultaneously, such as may be found in an aircraft, train or ship having hundreds of passengers. In general, even for those wireless systems having adequate bandwidth, a degradation in the quality of the video signal and viewing experience may occur due to damaged data packets that are discarded, unacceptable bit-error-rates, and software “glitches” leading to system shut-downs.

In addition to the limitations discussed above regarding the delivery and reception of a video signal, audio signal transmission in the same or similar environments may be degraded as well. COTS wireless audio systems for personal use do not elegantly allow for multiple users simultaneously. Typically, available systems are limited to one or more users on a single channel. Further, the quality of the audio signal produced is often marginally acceptable, and certainly not adequate for listening to high quality, high fidelity audio signals.

It is critical that any solution proposed for the delivery of video, audio and/or data signals to a user within an aircraft must meet strict certification requirements. Frequency interference, passenger and crew safety, and system reliability are just a few of the numerous concerns that must be addressed before any system may be certified flight worthy by the FAA. Other similar certifications may be required by other commercial transport systems, users in fixed locations, etc.

Hence, there is a need for a wireless video entertainment system that overcomes one or more of the drawbacks identified above.

### SUMMARY

The wireless video entertainment system herein disclosed advances the art and overcomes problems articulated above by providing an user friendly, integrated system for the delivery and playback of video, audio and data signals.

In particular, and by way of example only, in one embodiment a video entertainment system is provided including: a means for a user to request transmission of a video signal to a personal electronic device co-located with the user; a means for processing and storing the video signal with forward-error correction methods prior to and during transmission to the personal electronic device; and a means for wireless transmission of the processed video signal to the personal electronic device, for displaying the video signal to the user, the transmission means having an RF power combiner for bundling hardware and isolating a plurality of video signals transmitted to a plurality of users on one or more frequency bands.

In another embodiment, a wireless video entertainment system includes: a device for providing a video signal; an encoder for pre-conditioning the video signal; a server for storing and processing the pre-conditioned video signal; one or more access modules for wireless transmission of the pre-conditioned and processed video signal to a personal electronic device of a user, each access module having an RF combiner for bundling and isolating a plurality of the video signals; and a software interface for interconnecting the personal electronic device with the one or more access modules and the server.

Yet another embodiment provides a method for delivering wireless video entertainment including: identifying a video signal request transmitted by a user; pre-conditioning the requested video signal; storing and processing the pre-conditioned video signal prior to transmission to the user; and wirelessly transmitting the video signal from an access module to a personal electronic device co-located with the user, the access module having a RF power combiner for bundling and isolating a plurality of video signals.

### BRIEF DESCRIPTION OF THE DRAWINGS

FIG. 1 is top view of a section of an aircraft cabin with varying zones of Ricean and Rayleigh fading;

FIG. 2 is a schematic of a wireless video entertainment system, according to an embodiment;

FIG. 3 is a schematic of a RF power combiner, according to an embodiment;

FIG. 4 is a schematic of a wireless audio receiver, according to an embodiment;

FIG. 5 is a schematic of a processor in a wireless headset, according to an embodiment;

FIG. 6 is a schematic of an aircraft cabin RF fade mapping sub-system, according to an embodiment;

FIG. 7 is a top view of the distribution of in-flight entertainment to compartments of an aircraft cabin, according to an embodiment; and

FIG. 8 is a flow chart of a method for providing wireless video, audio and data entertainment, according to an embodiment.

### DETAILED DESCRIPTION

Before proceeding with the detailed description, it should be noted that the present teaching is by way of example, not by limitation. The concepts herein are not limited to use or application with one specific type of wireless video entertainment system in a specific environment. Thus, although the instrumentalities described herein are for the convenience of explanation, shown and described with respect to exemplary embodiments, the principles herein may be equally applied in other types of wireless video entertainment systems in a variety of different environments.

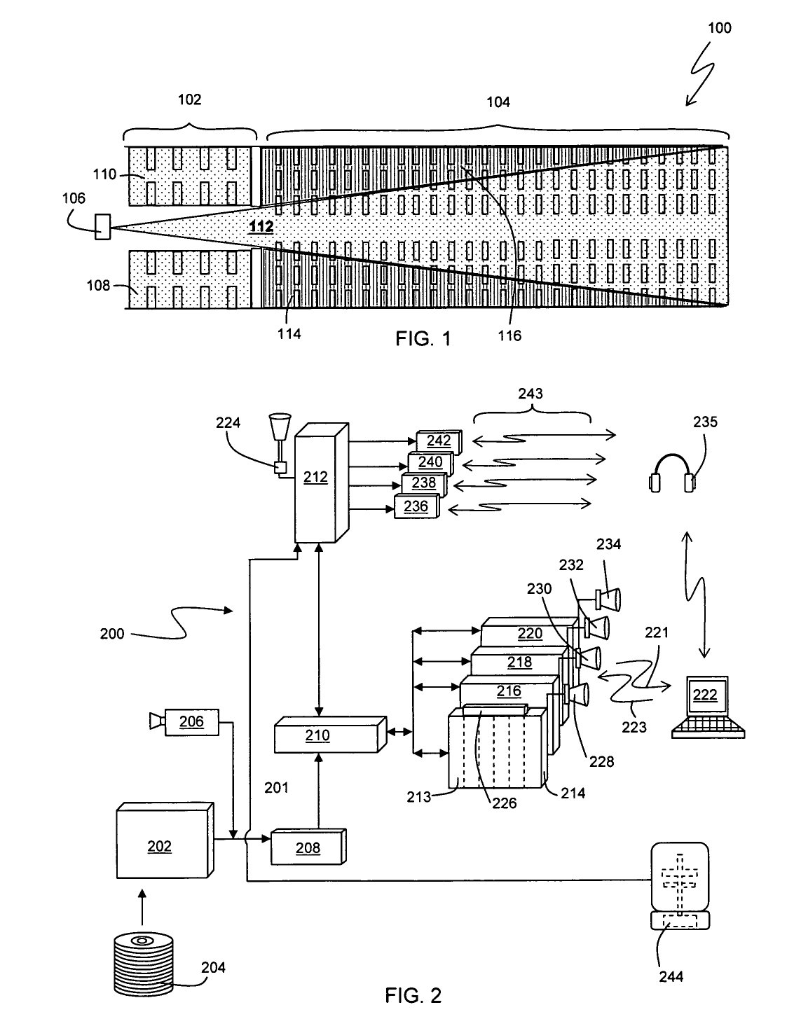

An aircraft may have one or more separate and distinct cabins or passenger compartments (e.g. compartments 102, 104 (FIG. 1)). It can be appreciated, however, that a system 200 may also be integrated into other types of commercial transport and privately owned vehicles having a plurality of passenger compartments, seats or cabins, to include but not limited to, commercial rail cars, passenger ships, etc. Further, system 200 may be used in fixed locations such as buildings having one or more rooms for viewing video tapes/disks, live video feeds, etc. Referring now to FIG. 2, the architecture of a wireless video entertainment system 200, according to an embodiment, is presented. Of note, the architecture presented in FIG. 2 is representative of a system designed, in one embodiment, for integration into commercial aircraft.

System 200 includes at least one source 202 of a recorded video signal. Source 202 may be any of a number of video sources well known in the art, such as a real-time satellite feed or a DVD player and the corresponding DVDs 204. Alternatively, system 200 may include a video camera 206 providing a real-time or near real-time video stream or signal in accordance, for example, with the National Television Standards Committee standards. Stated differently, system 200 may include “broadcast” video. Further, source 202 may include a combination of video sources available for selection and use depending on the requests of various users.

Each source, e.g. source 202, is in electronic communication with a MPEG (Moving Pictures Expert Group) encoder 208. Encoder 208 is positioned to receive a video/audio signal or stream from a source 202, 206. Typically, a single video signal may be as large as 12 Mbps. Encoder 208 pre-conditions or transforms the video signal into an MPEG signal on the order of 2 Mbps, thereby allowing for a plurality of signals to fit within the bandwidth available for use by system 200. The MPEG video stream may be any of a number of MPEG video/audio signals known in the art, to include MPEG-2 and MPEG-4, and is comprised of I, B, and P data frames, each representing a basis or estimation of each video frame delivered usually at a rate of 15 to 30 frames per second. As discussed in greater detail below, encoder 208 transmits the video stream, through a switch 210, to a system 200 server 212 according to a predetermined data protocol.

The protocol may be either a Transmission Control Protocol/Internet Protocol (“TCP/IP”) or a User Datagram Protocol (“UDP”). In one embodiment, both protocols are used in varying combinations depending on system 200 requirements. In at least one embodiment, a UDP-Lite protocol is used to transmit data throughout the Ethernet connections of system 200. As can be appreciated by those skilled in the art, TCP/IP is the standard Internet protocol, however, it may be used in a private local area network (“LAN”) such as system 200 as well. TCP/IP is a two-layer protocol that manages the packaging of data streams into discrete, smaller packets of data for transmission (“TCP”). Further, the protocol manages the addressing of each data packet (“IP”).

In contrast with TCP/IP, UDP and UDP-Lite contain minimum protocol constraints and function controls. For example, UDP does not require a “handshake” between sending and receiving systems, therefore connections are established faster than with TCP/IP. Unlike TCP/IP, which maintains a connection state between the send and receive systems, UDP can typically service more active clients for a particular application by eliminating the connection state requirement. Also, the rate of data transfer with UDP is generally faster, as UDP does not typically have a congestion control mechanism to control the transfer of data between send and receive systems when the data link becomes congested. As such, the transfer rate of data is not limited or reduced by the protocol. Further, the header overhead in each data segment is smaller with UDP (e.g. 8 bytes versus 20 bytes per segment).

The UDP-Lite protocol, available with IPv6 (Internet Protocol Version 6), provides even greater flexibility and an ability to customize packet error control and the subsequent transmission of “damaged” packets. With TCP/IP and UDP, damaged packets of data are immediately discarded and not allowed to propagate through to a receiving system or subsystem. Often times, some or all of the damaged data might have been salvaged by secondary FEC (“forward error correction”) processing and/or the operation of the receiving video CODEC (“coder/decoder”). UDP-Lite permits the inclusion of damaged CRC (“cyclic redundancy checked”) packets in the transmitted signal, thereby potentially enhancing the quality of the video signal/image received by a user.

UDP and UDP-Lite protocols are not without limitations. The reliability of a data transfer is greater with TCP/IP, wherein significant effort is expended to ensure data is received at the desired location. To account for the inherent “unreliability” of data delivery associated with UDP and UDP-Lite, systems 200 employing these protocols take other steps, such as those discussed below, to ensure adequate data delivery and quality image presentation.

Returning once again to FIG. 2, switch 210 provides the interconnection between server 212 and one or more access modules, of which access modules 214, 216, 218 and 220 are exemplary. As shown, switch 210 is positioned to transfer video signals from encoder 208 to server 212. Further, processed video signals, as described in greater detail below, are transmitted from server 212 to access modules 214-220. Also, information and data signals received by access modules 214-220 from one or more personal electronic devices (“PED”) 222, are transmitted to server 212 through switch 210.

Server 212 is the central server/processor for the LAN which is system 200. Server 212 may be any of a type of servers well known in the art for the control and processing of multiple RF and IR signals sent to, and received from, multiple sources. In at least one embodiment, server 212 is a complete media center providing video, audio and data signals for the benefit of one or more users. Embedded within server 212 is an operational software to control server functions. Embedded software may allow server 212 to manage data transfer in accordance with licensing requirements, and may act to clear data from PED 222 substantially concurrently with use, thereby preventing unauthorized copying, etc. Further, server 212 may include encrypt/decrypt capabilities for processing signals either having or desiring encryption protection.

As shown, server 212 may include a transmit/receive antenna 224 for Internet/remote email interoperability. Specifically, satellite signals for Internet/email use may be received by antenna 224. In at least one embodiment, the received signals are a direct feed into server 212. Similarly, data signals (e.g. Internet access, email) from a user are transmitted through antenna 224 to the appropriate satellite or ground based system.

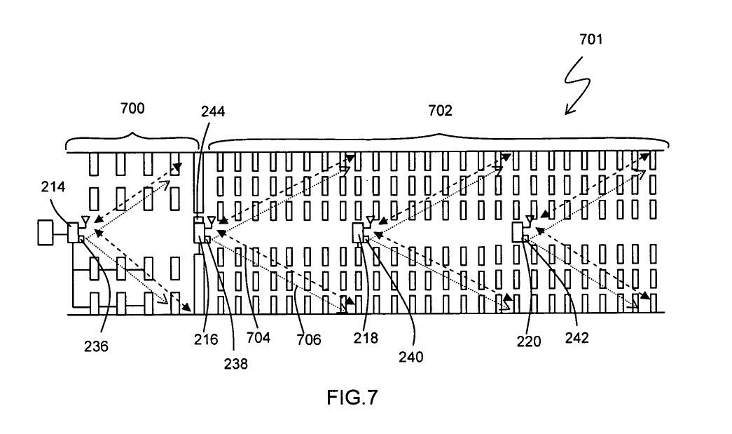

As noted above, switch 210 is in electronic communication with a plurality of access modules 214-220. Access modules 214-220 may be positioned throughout passenger compartments, such as compartments 700 and 702 (FIG. 7) in aircraft cabin 701, depending on operational needs and system specifications. For example, a single access module 214 may be used to service a compartment 700 having relatively few seats/passengers. Alternatively, multiple access modules 216-220 may be required to service areas, such as compartment 702, having a higher density of seats, persons, etc.

Each access module 214-220 includes a plurality of access points of which access point 213 is exemplary. In at least one embodiment, access point 213 is a circuit card. As shown in FIG. 2, each access module 214-220 also includes a RF power combiner, e.g. RF power combiner 226. RF power combiner 226 is positioned to bundle or combine a plurality of RF signals received from server 212 through one or more of the access points 213. The bundled signals are then individually distributed to discrete receiving locations or PEDs 222, during which time one signal is isolated from the next.

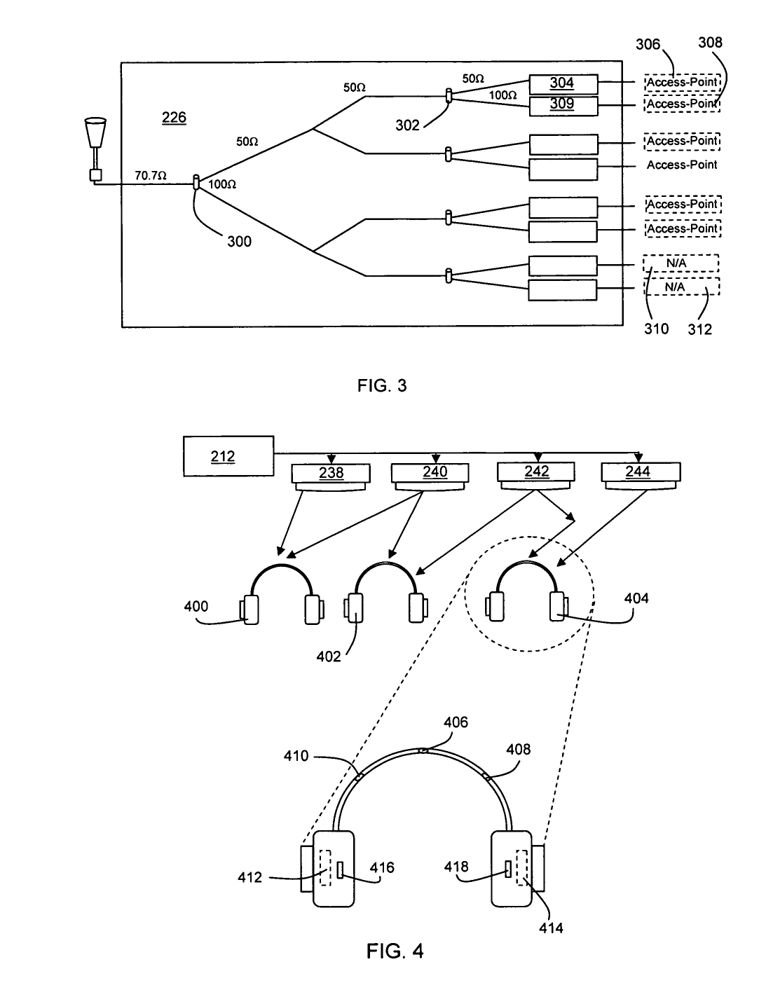

FIG. 3 provides a simplified schematic of at least one embodiment of RF power combiner 226. As shown, RF power combiner 226 may be an 8-way, ¼ λ power converter having a plurality of resistors, of which resistors 300 and 302 are exemplary. In one embodiment, resistors in the range of 50-100 ohms are used. Although multiple isolators are included (eight in the case of RF power combiner 226 depicted in FIG. 3), a single isolator, e.g. isolator 304, is typically associated with a single access point, e.g. access point 306, which may be analogous to access point 213 in FIG. 2. In the case of system 200, access points may represent differing RF frequency bands for use by system 200. For example, access point 306 may be designated RF Band “1”, and may operate at 5.200-5.225 GHz. Similarly, access point 308, connected to isolator 309, may be associated with an RF frequency band in the range of 5.225-5.250 GHz. The remaining access points may, in at least one embodiment, operate between 5.250 and 5.350 GHz, each having a distinct and equal band width.

It can be appreciated, however, that operation of system 200 is not limited to frequencies between 5.200 GHz and 5.350 GHz. On the contrary, operational frequencies for system 200 may be selected from a group of frequencies which may include, but are not limited to, unlicensed bands and frequencies in the range of: 2.4 GHz, 5 GHz, 6 GHz, 20 MHz and others. In the embodiment shown in FIG. 3, two access points 310 and 312 are not used for system 200 operation, and are in fact “locked out” by system 200 software to prevent use. These access points and the corresponding frequency band 5.15-5.20 GHz may be designated instead for aviation MLS use.

In at least one embodiment, frequencies may be reused. In particular, a frequency used in a forward area of an aircraft, for example compartment 700 in FIG. 7, may be used again in a rear area (e.g. compartment 702) depending on the distance between the access modules transmitting at that same frequency. Frequency reuse provides greater user capacity and flexibility to system 200.

Referring back to FIG. 2, in addition to an RF power combiner 226, a transmit/receive antenna, i.e. antennas 228, 230, 232 and 234, is integral to each access module, i.e. modules 214220. Multiple antennas may be used for each access module 214-220 to provide antenna diversity and hence better signal reception/transmission. In at least one embodiment, antenna diversity is used at the receiving end of a video signal, i.e. the PED 222 end, as well. Signals processed and transmitted by server 212 (represented by arrow 221) are wirelessly passed to PED 222 via antennas 228-234. Also, signals transmitted by PED 222 for use by system 200 (represented by arrow 223), are received by the antennas 228-234. The isolation feature of RF power combiner 226 helps to ensure signal integrity and separation, despite the transmission of multiple signals and the relative close proximity of access points within a given access module. Of note, MIMO (multiple input, multiple output) may be employed in the system antenna and radio system to enhance link performance.

PED 222 is a device through which a video signal received from an access module 214-220 may be viewed by the user. PED 222 may be a laptop computer or other personal device belonging to a user, to include but not limited to a cellular phone, personal digital assistant (“PDA”), etc. Alternatively, PED 222 may be a device provided to users for their temporary use. For example, PED 222 may be a Touch Display Unit (“TDU”). In at least one embodiment, PED 222 includes an “error-resilient” video CODEC for processing the video signals received. Further, internet access and email receipt/transmission are facilitated by PED 222, and in at least one embodiment a user may listen to an audio signal as well. Also, as discussed below, the remote selection of a desired audio channel, using IR proximity, may be accomplished by placing an audio receiver 235 in close proximity to PED 222. Graphical user interface (“GUI”) software may be embedded in PED 222 to facilitate component and system functioning.

In addition to server 212, access modules 214-220, RF power combiner 226, and PED 222, system 200 may include multiple audio modules positioned throughout passenger compartments 700, 702 (FIG. 7) or user areas, of which audio modules 236, 238, 240 and 242 in FIG. 2 are exemplary. Audio modules 236-242 may be co-located with access modules 214-220, as shown in FIG. 7. Alternatively, audio modules 236-242 may be located at different locations throughout passenger compartments 700 and 702. In one embodiment, audio modules 236-242 are infrared (“IR”) modules which transmit an IR signal carrying the entire suite of audio channels for system 200. A low-power CDMA (Code Division Multiple Access) or TDMA (Time Division Multiple Access) technique may enable a large number of wireless users to be multiplexed on one IR band.

Audio modules 236-242 may transmit the IR audio signal (represented by arrows 243 in FIG. 2) to a plurality of audio receivers, such as audio receiver 235. The standard used for the transmission and receipt of IR audio signals between audio modules 236-242 and audio receivers 235 may be the standard well known in the art as “Bluetooth”. In one or more embodiments, audio receiver 235 is a wireless headset available to a user. Cross-referencing for a moment FIGS. 2 and 4, server 212 may transmit to audio modules 236-242 an IR audio signal which may be further transmitted to one or more headsets 400, 402, and 404 by one or more of the audio modules 236-242.

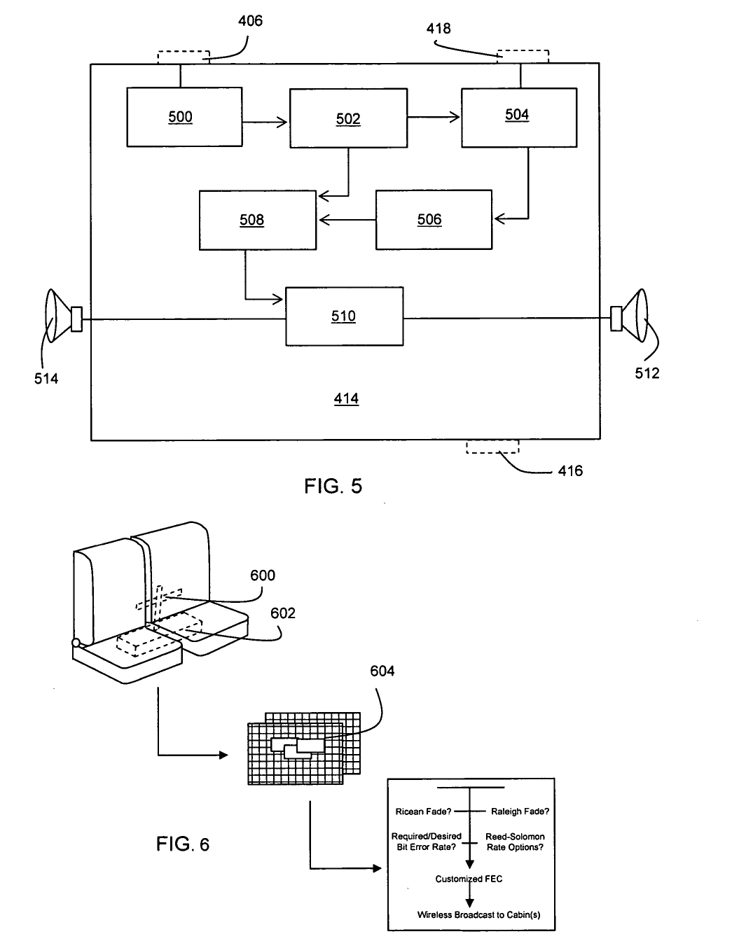

As shown in FIG. 4, each headset (e.g. headset 404) may include at least one IR signal receiver/detector 406. For the purposes of redundancy, multiple IR receiver/detectors 408, 410 may be included as well. Further, each headset 404 includes at least one removable, rechargeable battery 412. A battery re-charger (not shown) may be used to periodically recharge batteries and maintain a ready supply of fully-charged batteries. A processor 414 is located within headset 404 to perform multiple signal processing functions as detailed below and in FIG. 5. Also, each headset 404 may include a volume control mechanism 416 and a channel selector 418. In at least one embodiment, headset 404 is cable of receiving and playing high quality, high fidelity audio signals such as Dolby and Pro Logic audio imaging. Additionally, the headset may produce cabin noise cancellation effects as a stand-alone system, or it may receive phase noise cancellation signals from a RF or IR link. In particular, the head-end system samples ambient cabin noise with a sensor (predictable engine noise) and anticipates and delivers the anti-phase to the cabin headset via one of the wireless means, i.e. RF or IR.

In the block diagram of FIG. 5, processor 414 includes a data register 500 for receiving the IR, multi-channel audio broadcast transmitted through an IR detector, e.g. IR detector 406. In one embodiment, the IR signal is a 4-Mbps IR signal. The audio signal may correlate to and synchronize with a video signal being processed and transmitted by system 200, or alternatively, the audio signal may be a stand-alone signal for the listening pleasure of a user. All receiving devices, e.g. headset 404 in FIG. 4, receive all audio channels transmitted using the IR signal.

Still referring to FIG. 5, a data synchronizer 502 is in electronic communication with data register 500. In at least one embodiment, data synchronizer 502 works in conjunction with a CDMA frame separator 504 to synchronize a selected audio channel with the corresponding video data packets, and to correlate user addresses. In yet another embodiment, the data stream received by a headset (e.g. headset 404 in FIG. 4) is in a TDMA format. Regardless, correlation may occur as users select an audio channel via channel selector 418. Alternatively, an automated channel selection process, e.g. IR proximity association, may be used. Using this method, headset 404 is held in close proximity to PED 222. PED 222 “programs” headset 404 to receive the audio channel associated with the video signal being received and processed by the PED 222. Regardless of the method of channel selection, a single channel is selected from the entire stream of audio channels carried by the transmitted IR signal.

A data buffer 506 receives the data stream from CDMA frame separator 504 and transmits the data to a digital-to-analog converter 508. The digital signal is converted to an analog signal, and the analog signal is passed to an amplifier 510, and finally to the ear pieces 512, 514 of a headset (e.g. headset 404). A volume control device 416 may be used to adjust volume level based on user preference.

As discussed previously, significant signal fading (Rayleigh and Ricean) can detract from system 200 performance, and the quality of the video signal received by a user. Also, signal blockage from seats, passengers, crew members, etc. can reduce signal quality as well. To minimize the impact of signal fade and blockage, system 200 may include an RF fade mapping subsystem 244 for analyzing in real or near-real time localized fading and blockage of transmitted RF video signals.

Returning to FIG. 2, one or more fade mapping subsystems 244 may be in electronic communication with server 212. Cross-referencing FIG. 2 and FIG. 6, each seat or grouping of seats may contain a subsystem 244 for measuring and transmitting RF signal characteristics localized to the immediate vicinity of the subsystem 244. Alternatively, a single subsystem 244 may be used to map an entire passenger compartment, room, etc. The measured data is used to create a 3-D mapping of passenger compartment fading, which in turn is used to select an optimal forward error correction or FEC to be applied to a RF video signal transmitted to one or more PEDs 222 in the vicinity of subsystem 244. The specific elements of RF fade mapping subsystem 244 are set forth and disclosed in U.S. patent application Ser. No. 10/998,517, filed on 29 Nov. 2004, entitled “Cellular Wireless Network for Passengers Cabins”, and U.S. patent application Ser. No. 10/894,334, filed on 19 Jul. 2004, entitled “Configurable Cabin Antenna System and Placement Process”, the disclosures of which are incorporated by reference herein. As shown in FIGS. 6 and 7, subsystem 244 may be embedded in a seat or otherwise located in a passenger compartment, e.g. passenger compartment 702 (FIG. 7). The embedded subsystem 244 may include an antenna/sensor 600, as well as an x,y,z positioner 602. Software contained either in subsystem 244 or server 212 analyzes measured data and creates the 3-D mapping 604.

As shown in FIG. 6, the 3-D mapping 604, in turn, may be used to: (1) determine whether there is a predominant fading phenomenon present (i.e. Rayleigh or Ricean) and the magnitude of the fading; (2) correlate the fade and blockage characteristics with a desired bit error rate; (3) select an optimal Reed-Solomon code rate (e.g. 0.50., 0.33); and (4) define a customized FEC for a given signal transmitted to a given location. By using localized RF fading and blockage data to optimize the Reed-Solomon code rate, and hence the FEC applied to the RF video signal, the quality of video signal throughout a passenger compartment 700, 702 can be enhanced. Further, those skilled in the art will appreciate that the application of a Reed-Solomon code rate of 0.50 to one or more video channels, especially to those channels transmitted within a low-fade/blockage area such as compartment 700 in FIG. 7, results in excess bandwidth for those channels. The excess or overhead bandwidth can be used by system 200 to provide Internet/email access to all locations within both compartments 700, 702 (FIG. 7). A further benefit of tailoring and optimizing the FEC code rate based on localized signal fading and blockage is that forward areas, such as the “first class” areas in aircraft, may receive more video channels than rear areas (e.g. “coach” class). For example, the first class section on an aircraft may receive 24 DVD-quality video channels and Internet/email access, while coach cabins may only receive 12 DVD-quality video channels, as well as Internet and email access.

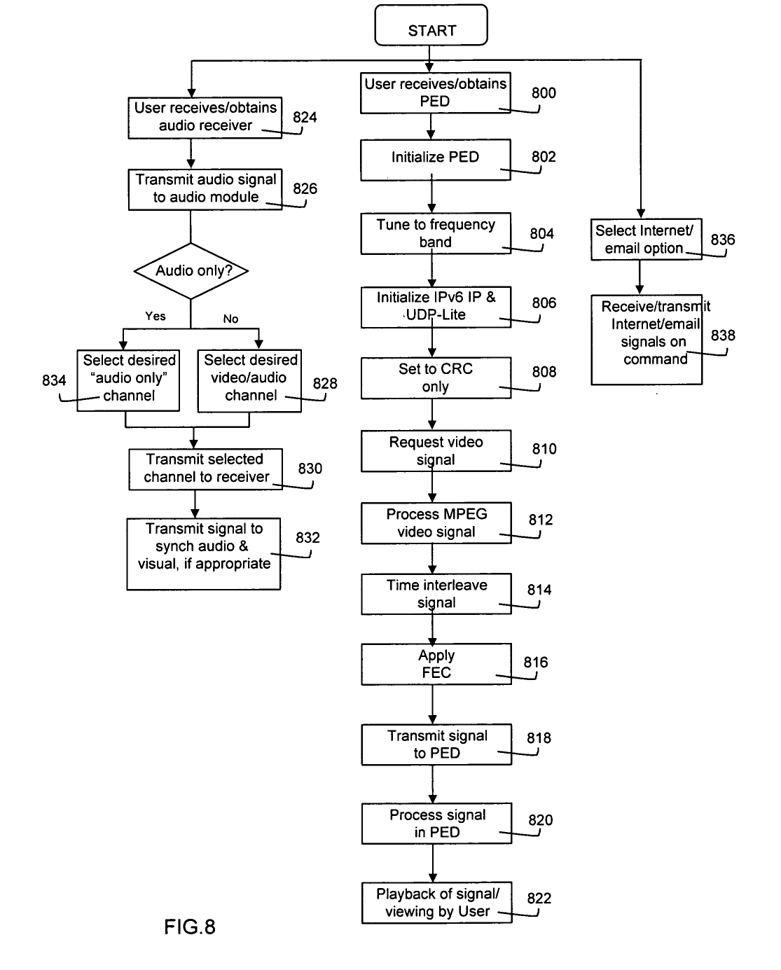

Considering now the operation of system 200, as represented by the flow chart of FIG. 8, a user will have a PED at their seat location (block 800) for receiving a video and, in at least one embodiment, an audio signal transmitted wirelessly to the PED. Alternatively, the user will have an audio receiver, such as a headset, for receiving audio signals. As discussed above, the PED may be a laptop computer, cell phone, PDA, etc. of the user, or it may be a device provided with the system, such as a TDU. Regardless, the PED is initialized by the user, block 802. Initiation includes establishing a connection to the wireless network via a protocol such as DHCP (“dynamic host configuration protocol”). At the time of initiation, system specific software provides a “user friendly” graphical user interface (“GUI”) which facilitates user selections and requests. The GUI software may also provide a “quick recovery” feature for eliminating or minimizing operating system “crashes”, and for quickly recovering from service interruption events.

In at least one embodiment, initiation includes preparing the PED of the user to receive wireless delivery of a requested file. Preparation may be via an 802.11“x” radio connection, which may be an 802.11a radio system. In one embodiment, an 802.11a radio system with orthogonal frequency-division multiplexing is the standard for the network of system 200. Alternatively, the network may operate using an 802.11b, Ultra High Band, or other standard. The PED is tuned to the proper frequency band, block 804, depending on the standard selected. Further, the desired internet protocol stack, e.g. IPv6 IP, is initiated, along with the UDP-Lite protocol, block 806. Also, the protocol is set to provide CRC (“cyclic redundancy checked”) on only the “I-frame” and header data (block 808). This restriction, in conjunction with the use of an error-resilient video CODEC (e.g. MPEG-4 or H.263+), further ensures that damaged data packets are transmitted to and received by the PED, and that the packets are used to construct the video image presented.

Prior to, contemporaneous with, or after receipt of a request for a video signal (block 810), the server processes the MPEG video signal, block 812, to provide multiple instances of “I-frame” and header data. Redundancy and the “weighting” of the signal in favor of the “I-frames” and header data is desired, and may be required, when using the UDP-Lite protocol discussed previously. Redundancy and weighting of key “I-frame” and header data helps to ensure the user receives a quality, uninterrupted video image. Further, the MPEG I-frames are time interleaved (block 814) with other signals over a designated extended period of time. In at least one embodiment, the time period is approximately four seconds. As with redundancy, time interleaving helps to ensure the delivery of a quality image, despite damaged data packets, dropped data, etc. In particular, time interleaving over extended periods (e.g. seconds or minutes) compensates in part for temporary signal blockage due to passenger movements, etc.

An encoded MPEG video signal may be stored in the server until a request for the video signal is received. Once a request is received, the video signal or stream is exported to the PED via a wireless transmission of data over one of the channels associated with one of the access modules. Transfer of video data may take up to approximately 20 minutes to complete, however, viewing of the video images may occur immediately. To accommodate multiple users simultaneously, more than one video signal transfer may occur over a given channel. Of note, a customized FEC code rate is applied to the signal (block 816) based on the processed data of the RF fade mapping subsystem, as well as previously established statistical data regarding compartment fading, blockage, etc. The code rate associated with the FEC may depend on the location of the requesting user. Signals may be coded with area specific code rates (e.g. 0.50 vs. 0.33) depending on localized fading and blockage phenomena.

The “corrected” signal is transmitted (block 818) to the requesting PED, wherein the video signal is processed (block 820) to: (a) undo redundancy; (b) conduct a triple voting process on the I-frame data; and (c) interface the video signal with an error resilient media-player (CODEC) resident in the PED. Once processed, the video signal may be viewed by the user, block 822.

In one embodiment, an audio signal is transmitted to an audio receiver (e.g. wireless headset, wired headset, TDU, etc.) concurrent with, and synchronized to, the delivery of a video signal to the PED. Initially, a user must have or receive an audio receiver for use with the system, block 824. At the appropriate time, an IR audio signal containing all audio channels is transmitted from the server to an audio module, block 826. The user may select the desired channel (block 828) using one of several methods described above. In particular the user may select a channel using a channel selector on the audio receiver, or he/she may elect automated channel selection using, for example, IR proximity. Once selection is complete, the audio module transmits to the audio receiver (headset, etc.), typically in a wireless mode, the desired audio channel, block 830. During operation, the PED transmits either a continuous or periodic synchronization signal (block 832) to the access module, permitting the server to ensure that the audio output is in synch with the video output.

In the event that a user desires solely to listen to an audio signal, the user may elect to do so by selecting the audio channel of choice, block 834. In this instance the audio channel is transmitted to the audio receiver, and the PED is not required or involved.

Yet another embodiment of the operation of system 200 is the selection of a data signal for Internet access or email use. After initializing the PED in essentially the same manner as disclosed above, block 802, the user selects the Internet or email option presented by the GUI software, block 836. Data signals are wirelessly received by the access module from the PED, and are subsequently passed to the server wherein the signal is transmitted to the outside world via an integrated antenna (block 836). Alternatively, a data signal is received by the server (block 838) and transmitted from the satellite-server-access module to the PED, whichever is appropriate.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall therebetween.

What is claimed is:

1. A wireless video entertainment system comprising:
a means for a user to request transmission of a video signal to a personal electronic device co-located with the user;
a means for processing and storing the video signal with forward-error correction methods prior to and during transmission to the personal electronic device; and
a means for wireless transmission of the processed video signal to the personal electronic device, for displaying the video signal to the user, the transmission means having an RF power combiner for bundling hardware and isolating a plurality of video signals transmitted to a plurality of users on one or more frequency bands.

2. The system of claim 1, wherein the requesting means is the personal electronic device.

3. The system of claim 1, wherein the personal electronic device is selected from a group consisting of: a laptop computer or a touch display unit.

4. The system of claim 1, wherein the processing and storing means is a server in electronic communication with the transmission means.

5. The system of claim 1, wherein the processed video signal is a 5-GHz signal.

6. The system of claim 5, wherein the processed video signal is a 5-GHz, 802.11a OFDM signal.

7. The system of claim 5, wherein the processed video signal is in a U-NII frequency band range of 5.200 GHz to 5.350 GHz.

8. The system of claim 5, wherein the processed video signal is in a U-NII frequency band range of 5.745 to 5.805 GHz.

9. The system of claim 1, wherein the processed video data is interleaved temporally with one or more subsequent video data sequences, and further wherein transmission of MPEG I, B, and P frames and associated packet headers of the processed video signal is facilitated through weighted redundancy of most critical frame data.

10. The system of claim 1, wherein the processed video signal includes a customized forward error correction code.

11. The system of claim 10, wherein a statistical 3-D mapping of RF signal fading is calculated and used to customize the forward error correction code.

12. The system of claim 11, wherein the forward error correction code is selected from a group consisting of: a Reed-Solomon code of 0.33 or a Reed-Solomon code of 0.5.

13. The system of claim 1, wherein the transmission protocol of the video signal is a IPv6 IP protocol stack supporting UDP-Lite, allowing damaged video packets to propagate to an error-resilient video player application.

14. The system of claim 1, wherein the video signal is selected from a group consisting of: a video-on-demand signal or a broadcast video signal.

15. The system of claim 1, wherein the personal electronic device includes an error-resilient video CODEC.

16. The system of claim 1, further comprising a plurality of transmission and receive antennas for antenna diversity, wherein the antennas also support MIMO (multiple input multiple output) radio technology.

17. The system of claim 1, further comprising a means for the user to transmit and receive electronic mail.

18. The system of claim 1, further comprising a means for the user to transmit and receive Internet signals.

19. The system of claim 18, wherein the protocol for the transmission and receipt of Internet signals is a TCP/IP protocol.

20. The system of claim 1, further comprising:
a means for wireless transmission of an IR audio signal; and
a means for receiving the IR audio signal.

21. The system of claim 20, wherein the means for wireless transmission of the IR audio signal is an IR module.

22. The system of claim 20, wherein the means for receiving the IR audio signal is a headset.

23. The system of claim 22, wherein the headset supports Dolby and ProLogic audio imaging, and further wherein the headset supports cabin noise cancellation.

24. The system of claim 22, wherein the headset is programmed to operate on a unique RF channel matching a channel of the video signal.

25. The system of claim 20, wherein transmission of the IR audio signal is synchronized with a received video signal.

26. The system of claim 20, wherein the IR audio signal is isochronously transported with a received video signal.

27. The system of claim 1, wherein the system is embedded in a vehicle, and further wherein the vehicle is selected from the group consisting of: an aircraft, a railcar, a ship, or a personally owned vehicle.

28. A wireless video entertainment system comprising:
a device for providing one or more video signals;
an encoder for pre-conditioning each video signal based on a measurement of probable channel conditions;
a server for storing and processing the pre-conditioned video signals;
at least one access module for wireless transmission of the pre-conditioned and processed video signal to a personal electronic device of a user, each access module having an RF combiner for bundling hardware and isolating a plurality of the video signals; and
software for interfacing the personal electronic device with the one or more access modules and the server.

29. The system of claim 28, wherein the personal electronic device is selected from a group consisting of: a laptop computer or a touch display unit.

30. The system of claim 28, wherein personal electronic device is a touch display unit.

31. The system of claim 28, wherein the video signal is a 5-GHz signal.

32. The system of claim 31, wherein the video signal is in a U-NII frequency band range of 5.200 GHz to 5.350 GHz.

33. The system of claim 31, wherein the video signal is in a U-NII frequency band range of 5.745 to 5.805 GHz.

34. The system of claim 28, wherein a video data sequence is interleaved with one or more subsequent video data sequences, and further wherein transmission of MPEG I, B and P frames and associated packet headers of the video signal is facilitated through weighted redundancy of most critical frame data.

35. The system of claim 28, wherein the video signal includes a customized forward error correction code.

36. The system of claim 35, wherein a statistical 3-D mapping of RF signal fading is calculated and used to customize the forward error correction code.

37. The system of claim 35, wherein the forward error correction code is selected from a group consisting of: a Reed-Solomon code of 0.33 or a Reed-Solomon code of 0.5.

38. The system of claim 28, wherein the transmission protocol of the video signal is a IPv6 IP protocol stack supporting UDP-Lite, allowing damaged video packets to propagate to an error-resilient video player application.

39. The system of claim 28, wherein the personal electronic device includes a video CODEC with error concealment capability.

40. The system of claim 28, further comprising a plurality of transmission and receive antennas for antenna diversity, wherein the antennas support MIMO (multiple input multiple output) radio technology.

41. The system of claim 28, further comprising a means for the user to transmit and receive Internet signals and electronic mail.

42. The system of claim 28, further comprising:
an IR module for wireless transmission of an audio signal; and
an audio receiver for receiving the audio signal.

43. The system of claim 42, wherein the audio receiver is a headset.

44. The system of claim 43, wherein the headset supports Dolby and ProLogic audio imaging, and further wherein the headset supports cabin noise cancellation.

45. The system of claim 28, wherein the system is embedded in a vehicle, and further wherein the vehicle is selected from the group consisting of: an aircraft, a railcar, a ship or a personally owned vehicle.

46. A method for providing wireless video entertainment comprising:
identifying a video signal request transmitted by a user;
pre-conditioning the requested video signal;
storing and processing the pre-conditioned video signal prior to transmission to the user; and
wirelessly transmitting the video signal from an access module to a personal electronic device co-located with the user, the access module having a RF power combiner for bundling hardware and isolating a plurality of video signals.

47. The method of claim 46, wherein the personal electronic device is selected from a group consisting of: a laptop computer or a touch display unit.

48. The method of claim 46, further comprising using a 5-GHz signal for transmission of video signals.

49. The method of claim 48, further comprising transmitting in a U-NII frequency band range, wherein the range is selected from a group consisting of: 5.200 to 5.350 GHz or 5.745 to 5.805 GHz.

50. The method of claim 46, wherein the pre-conditioning of the video signal further comprises:
interleaving a video data sequence temporally with one or more subsequent video data sequences; and
facilitating the transmission of MPEG I, B and P frames and associated packet header data through weighted redundancy of most critical frame data.

51. The method of claim 46, wherein the processing of the video signal further comprises applying a customized forward error correction code to the video signal prior to transmission.

52. The method of claim 51, further comprising:
generating a statistical 3-D mapping of compartment RF signal fading; and
applying the 3-D mapping to optimize the forward error correction code.

53. The method of claim 51, wherein the forward error correction code is selected from a group consisting of: a Reed-Solomon code of 0.33 or a Reed-Solomon code of 0.5.

54. The method of claim 46, wherein the personal electronic device includes a video CODEC with error concealment capability.

55. The method of claim 46, further comprising transmitting and receiving electronic mail through the personal electronic device.

56. The method of claim 46, further comprising transmitting and receiving internet signals through the personal electronic device.

57. The method of claim 56, wherein the protocol for the transmission and receipt of internet signals is a TCP/IP protocol.

58. The method of claim 46, further comprising wirelessly transmitting an audio signal to an audio receiver co-located with the user.

59. The method of claim 58, wherein the audio receiver is a headset.

60. The method of claim 59, wherein the headset supports Dolby and ProLogic audio imaging, and further wherein the headset supports cabin noise cancellation.

61. The method of claim 58, wherein transmission of the audio signal is synchronized with a video signal received on the personal electronic device.

62. The method of claim 58, wherein the audio signal isochronously transported with a video signal received on the personal electronic device.
